(19) United States
(12) Patent Application Publication
(10) Pub. No.: US 2024/0172146 A1
(43) Pub. Date: May 23, 2024

(54) TIME SYNCHRONIZATION IN A WIRELESS COMMUNICATION NETWORK

(71) Applicant: Telefonaktiebolaget LM Ericsson (publ), Stockholm (SE)

(72) Inventors: Zhipeng Lin, Nanjing (CN); Zhenhua Zou, Solna (SE); Yufei Blankenship, Kildeer, IL (US)

(21) Appl. No.: 18/551,938

(22) PCT Filed: Mar. 30, 2022
(86) PCT No.: PCT/IB2022/052972

§ 371 Date: Sep. 22, 2023

(30) Foreign Application Priority Data
Mar. 30, 2021 (WO) PCT/CN2021/083957

(51) Int. Cl. H04W 56/00; H04W 74/0833

(52) U.S. Cl. CPC H04W 56/0005; H04W 74/0833

(57) ABSTRACT

Systems and methods are disclosed for time synchronization in a wireless communication network. In one embodiment, a method performed by a wireless communication device comprises transmitting, to an access node, a signal for enhanced uplink timing estimation, wherein the signal occupies more or separate physical resources as compared to a corresponding signal transmitted for a purpose other than enhanced uplink timing estimation. The method further comprises receiving, from the access node, a message comprising timing-related information or clock time, responsive to transmitting the signal for enhanced uplink timing estimation. In this manner, the wireless communication network is able to meet enhanced timing error requirements, e.g., when inter-working with a Time Sensitive Network (TSN).

### RELATED APPLICATIONS

This application claims the benefit of international application serial number PCT/CN2021/083957, filed Mar. 30, 2021, the disclosure of which is hereby incorporated herein by reference in its entirety.

### TECHNICAL FIELD

The present disclosure generally relates to wireless or mobile communication. More particularly, the present disclosure relates to a method for time synchronization between an access node and a wireless communication device in a wireless communication network. The present disclosure also relates to apparatus and computer program product adapted for the same purpose.

### BACKGROUND

For supporting Time Sensitive Network (TSN) time synchronization, the Third Generation Partnership Project (3GPP) Fifth Generation System (5GS) is integrated with the external network as a TSN bridge (or time-aware system). There are two synchronization systems under consideration: 5GS synchronization and TSN domain synchronization. The 5GS synchronization is specified in 3GPP specifications for Next Generation (NG) Radio Access Network (RAN) synchronization, while the TSN domain synchronization follows Institute of Electronics and Electrical Engineers (IEEE) 802.1AS and provides synchronization service to the TSN.

The 5GS time synchronization needs to satisfy stringent accuracy requirements in order to support inter-working with a TSN. A demanding use case in the context of TSN-5GS interworking is when TSN Grandmaster clocks are located at end stations connected to User Equipment (UE)/Device-Side TSN Translators (DS-TTs). This new Release 17 use case involves two Uu interfaces in the 5GS path (i.e., 5GS ingress to 5GS egress) over which a TSN Grandmaster clock is relayed. One variant of the use case is illustrated in FIG. 1 where two UEs can be connected to different next generation NodeBs (gNBs), thereby introducing the potential for increasing uncertainty compared to the case where the two UEs are both connected to the same gNB.

The 5GS synchronicity budget is the portion of the end-to-end synchronicity budget applicable between the ingress and egress of the 5GS, as shown in FIG. 1. The per Uu interface synchronization error represents a portion of the end-to-end synchronicity budget and consists of the uncertainty introduced when (a) sending the Fifth Generation (5G) reference time from the gNB antenna to the UE antenna by including ReferenceTimeInfo in either a DLInformationTransfer Radio Resource Control (RRC) message or System Information Block (SIB) 9 (SIB9) and then (b) adjusting the 5G reference time to reflect the downlink propagation delay.

The range of uncertainty for a single Uu interface shown in Table 1 below was agreed at 3GPP TSG-RAN WG2 #113-e.

TABLE 1
Range of Uncertainty for a Single Uu interface

| Scenario | Single Uu interface Budget |
|---|---|
| Control-to-Control | ±145 ns to ±275 ns |
| Smart Grid | ±795 ns to ±845 ns |

The Release 17 RAN work item “Enhanced Industrial Internet of Things (IOT) and ultra-reliable and low latency communication (URLLC) support for NR” has the following objective, where propagation delay compensation is used to achieve time synchronization between the UE and its associated gNB:
5. Enhancements for support of time synchronization:
   a. RAN impacts of SA2 work on uplink time synchronization for TSN, if any. [RAN2]
   b. Propagation delay compensation enhancements (including mobility issues, if any). [RAN2, RAN1, RAN3, RAN4]

RAN1 has agreed in RAN1 #102e that:
The following options for propagation delay compensation are further studied in RAN1
   Option 1: TA-based propagation delay
      Option 1a: Propagation delay estimation based on legacy Timing advance (potentially with enhanced TA indication granularity).
      Option 1b: Propagation delay estimation based on timing advanced enhanced for time synchronization (as 1a but with updated RAN4 requirements to TA adjustment error and Te)
      Option 1c: Propagation delay estimation based on a new dedicated signaling with finer delay compensation granularity (Separated signaling from TA so that TA procedure is not affected)
   Option 2: RTT based delay compensation:
      Propagation delay estimation based on an RAN managed Rx-Tx procedure intended for time synchronization (FFS to expand or separate procedure/signaling to positioning).

### TA-Based Propagation Delay Compensation

The Timing Advance (TA) command is utilized in cellular communication for uplink transmission synchronization. It is further classified as two types:
1. In the beginning, at connection setup, an absolute timing advance command is communicated to a UE in the Medium Access Control (MAC) Protocol Data Unit (PDU) Random Access Response (RAR) or in the Absolute Timing Advance Command MAC Control Element (CE) of the Message B (MSGB).
2. After connection setup, a relative timing correction can be sent to a UE using Timing Advance Command MAC CE (e.g., UEs can move or due to multi-path because of changing environment).

The downlink Propagation Delay (PD) can be estimated for a given UE by (a) first summing the TA value indicated by the RAR and all subsequent TA values sent using the MAC CE and (b) taking some portion of the total TA value resulting from summation of all the TA values (e.g. 50% could be used assuming the downlink and uplink propagation delays are essentially the same). The PD can be utilized to understand time synchronization dynamics, e.g., accurately tracking the value of a clock at UE side relative to the value of that clock in other network nodes.

### RTT-Based Propagation Delay Compensation

For the Round-Trip Time (RTT) based method, the UE Receive-Transmit (Rx-Tx) Time Difference and/or gNB Rx-Tx Time Difference are measured at the UE side and the gNB side, respectively, and then used to derive the propagation delay.

For instance, two types of Timing Advance (TADV) can be defined:
Type1: TADV=(gNB Rx-Tx time difference)+(UE E-UTRA Rx-Tx time difference);
Type2: TADV=gNB Rx-Tx time difference.

With either Type 1 or Type 2, the propagation delay can be estimated as ½*TADV.

For Type 2 TADV, the Rx-Tx time difference corresponds to a received uplink radio frame containing PRACH from the respective UE.

### UL Time Synchronization in New Radio (NR)

In RRC_CONNECTED, the gNB is responsible for maintaining the timing advance to keep the L1 synchronized. Serving cells having uplink (UL) to which the same timing advance applies and using the same timing reference cell are grouped in a Timing Advance Group (TAG). Each TAG contains at least one serving cell with configured uplink, and the mapping of each serving cell to a TAG is configured by RRC.

For the primary TAG, the UE uses the Primary Cell (PCell) as a timing reference, except with shared spectrum channel access where a Secondary Cell (SCell) can also be used in certain cases (see clause 7.1 of 3GPP Technical Specification (TS) 38.133 V17.0.0). In a secondary TAG, the UE may use any of the activated SCells of this TAG as a timing reference cell but should not change it unless necessary.

Timing advance updates are signaled by the gNB to the UE via MAC CE commands. Such commands restart a TAG-specific timer which indicates whether the Layer 1 (L1) can be synchronized or not. When the timer is running, the L1 is considered synchronized; otherwise, the L1 is considered non-synchronized in which case uplink transmission can only take place on a Physical Random Access Channel (PRACH).

The TA timer is configured in TAG-Config Information Element (IE) in the IE MAC-CellGroupConfig which is used to configure MAC parameters for a cell group, including DRX. The TAG-Config IE is currently defined as:

-- ASN1START
-- TAG-TAG-CONFIG-START

| | |
|---|---|
| TAG-Config ::= | SEQUENCE { |
| tag-ToReleaseList | SEQUENCE (SIZE (1..maxNrofTAGs)) OF TAG-Id |

OPTIONAL, -- Need N

| | |
|---|---|
| tag-ToAddModList | SEQUENCE (SIZE (1..maxNrofTAGs)) OF TAG |

OPTIONAL -- Need N
}

| | |
|---|---|
| TAG ::= | SEQUENCE { |
| tag-Id | TAG-Id, |
| timeAlignmentTimer | TimeAlignmentTimer, |

...
}

| | |
|---|---|
| TimeAlignmentTimer ::= | ENUMERATED {ms500, ms750, ms1280, ms1920, |

ms2560, ms5120, ms10240, infinity}
-- TAG-TAG-CONFIG-STOP
-- ASN1STOP

TAG field descriptions

tag-Id
Indicates the TAG of the SpCell or an SCell. Uniquely identifies the TAG within
the scope of a Cell Group (i.e. MCG or SCG).
timeAlignmentTimer
Value in ms of the timeAlignmentTimer for TAG with ID tag-Id.

### Timing Estimation Error at gNB

PRACH timing detection error tolerance (see 3GPP TS 38.104 V17.1.0) in NR is described in the following excerpt from 3GPP TS 38.104:

### Start Excerpt from 3GPP TS 38.104

### 8.4.2 PRACH Detection Requirements

### 8.4.2.1 General

The probability of detection is the conditional probability of correct detection of the preamble when the signal is present. There are several error cases—detecting different preamble than the one that was sent, not detecting a preamble at all or correct preamble detection but with the wrong timing estimation. For AWGN and TDLC300-100, a timing estimation error occurs if the estimation error of the timing of the strongest path is larger than the time error tolerance given in Table 8.4.2.1-1. The performance requirements for high speed train (table 8.4.23-1 to 8.4.2.3-4) are optional.

TABLE 8.4.2.1-1
Time error tolerance for AWGN and TDLC300-100

| | | |
|---|---|---|
| PRACH | PRACH SCS | Time error tolerance |

| preamble | (kHz) | AWGN | TDLC300-100 |
|---|---|---|---|
| 0 | 1.25 | 1.04 us | 2.55 us |
| A1, A2, A3, B4, | 15 | 0.52 us | 2.03 us |
| C0, C2 | 30 | 0.26 us | 1.77 us |

### 11.4.2.2 PRACH Detection Requirements

### 11.4.2.2.1 General

The probability of detection is the conditional probability of correct detection of the preamble when the signal is present. There are several error cases—detecting different preamble than the one that was sent, not detecting a preamble at all or correct preamble detection but with the wrong timing estimation. For AWGN and TDLA30-300, a timing estimation error occurs if the estimation error of the timing of the strongest path is larger than the time error tolerance given in Table 11.4.2.2-1.

TABLE 11.4.2.2-1
Time error tolerance for AWGN and TDLA30-300

| | | |
|---|---|---|
| PRACH | PRACH SCS | Time error tolerance |

| preamble | (kHz) | AWGN | TDLA30-300 |
|---|---|---|---|
| A1, A2, A3, B4, | 60 | 0.13 us | 0.28 us |
| C0, C2 | 120 | 0.07 us | 0.22 us |

***** END EXCERPT FROM 3GPP TS 38.104 *****

### SUMMARY

Systems and methods are disclosed for time synchronization in a wireless communication network. In one embodiment, a method performed by a wireless communication device comprises transmitting, to an access node, a signal for enhanced uplink timing estimation, wherein the signal occupies more or separate physical resources as compared to a corresponding signal transmitted for a purpose other than enhanced uplink timing estimation. The method further comprises receiving, from the access node, a message comprising timing-related information or clock time, responsive to transmitting the signal for enhanced uplink timing estimation. In this manner, the wireless communication network is able to meet enhanced timing error requirements, e.g., when inter-working with a Time Sensitive Network (TSN).

In one embodiment, the signal for enhanced uplink timing estimation is a physical random access channel (PRACH) preamble for enhanced uplink timing estimation, wherein the PRACH preamble for enhanced uplink timing estimation occupies more or separate physical resources as compared to a PRACH preamble for a purpose other than enhanced uplink timing estimation.

In one embodiment, the message comprising the time-related information or clock time is a random access response. In one embodiment, the PRACH preamble has a bandwidth that is greater than 12 Physical Resource Blocks (PRBs) and the PRACH preamble for a purpose other than enhanced uplink timing estimation is 12 PRBs. In one embodiment, each PRB has a bandwidth of 15·2^{μ}·12 kilohertz, wherein 15·2^{μ} kilohertz is a subcarrier spacing of a respective cell on which the PRACH preamble. In one embodiment, the message comprises the timing-related information.

In one embodiment, the timing-related information comprises at least one of an absolute timing advance, a timing advance adjustment, and a propagation delay. In another embodiment, the timing-related information comprises a timing advance command the timing advance command has a granularity of K/2μ, 15·2^{μ} kilohertz where μ is an integer greater than or equal to zero is a subcarrier spacing of a respective cell on which the PRACH preamble is transmitted, and K is less than 1,024. In one embodiment, K is a power of 2 value. In one embodiment, K is 512, 256, 128, 64, 32, or 16.

In one embodiment, the PRACH preamble is transmitted on a PRACH resource from a common set of PRACH resources for all wireless communication devices in a respective cell on which the PRACH preamble is transmitted. In another embodiment, transmitting the PRACH preamble comprises transmitting the PRACH preamble in accordance with a RACH configuration that is cell-specific and common to all wireless communication devices in a respective cell on which the PRACH preamble is transmitted. In one embodiment, the PRACH preamble is one of a first set of PRACH preambles dedicated for time synchronization, the first set of PRACH preambles being different than a second set of PRACH preambles defined for the cell for random access for a purpose other than enhanced uplink timing estimation. In one embodiment, the wireless communication device transmits the PRACH preamble from the first set of PRACH preambles responsive to an indication from an upper layer that the random access procedure is for TSN time synchronization or an indication that a TSN protocol was started at the wireless communication device.

In one embodiment, transmitting the PRACH preamble is triggered by a downlink signal.

In one embodiment, transmitting the PRACH preamble while the wireless communication device is in a connected state. In one embodiment, transmitting the PRACH preamble is triggered by a downlink control information (DCI) received from the access node while the wireless communication device is in the connected state. In one embodiment, the DCI comprises a field that points to one or more PRACH occasions that are configured for enhanced uplink timing estimation. In one embodiment, transmitting the PRACH preamble while the wireless communication device is in the connected state is in accordance with a configuration received via device-specific or group-specific signaling.

In one embodiment, the PRACH preamble is transmitted on a dedicated PRACH resource, and a PRACH mask index value defined for clock synchronization in a Time-Sensitive Network (TSN) is used for the dedicated PRACH resource.

In one embodiment, transmitting the PRACH preamble comprises transmitting the PRACH preamble in accordance with a PRACH configuration for enhanced uplink timing estimation, wherein the PRACH configuration for enhanced uplink timing estimation is the same as a PRACH configuration for a purpose other than enhanced uplink timing estimation but with a configurable time domain modification.

In one embodiment, transmitting the PRACH preamble comprises transmitting the PRACH preamble in accordance with a first power ramping step size that is greater than a second power ramping step size used for PRACH preamble transmission for a purpose other than enhanced uplink timing estimation, a first back-off time that is smaller than a second back-off time used for PRACH preamble transmission for a purpose other than enhanced uplink timing estimation; or both the first power ramping step size and the first back-off time.

In one embodiment, the signal for enhanced uplink timing estimation comprises one or more uplink reference signals for enhanced uplink timing estimation, wherein the one or more uplink reference signals for enhanced uplink timing estimation occupy more or separate physical resources as compared a corresponding one or more reference signals transmitted for a purpose other than enhanced uplink timing estimation. In one embodiment, the one or more uplink reference signals for enhanced timing estimation comprise an aperiodic, semi-persistent, or periodic sounding reference signal (SRS); an aperiodic, semi-persistent, or periodic demodulation reference signal (DMRS); or an aperiodic, semi-persistent, or periodic phase tracking reference signal (PTRS). In another embodiment, the one or more uplink reference signals for enhanced timing estimation comprise a periodic reference signal. In one embodiment, the periodic reference signal has a bandwidth that is greater than a bandwidth of a corresponding periodic reference signal transmitted for a purpose other than enhanced uplink timing estimation. In another embodiment, the one or more uplink reference signals for enhanced timing estimation comprise a semi-persistent reference signal. In one embodiment, a periodicity of the semi-persistent reference signal is a function of a propagation delay estimation refresh periodicity. In one embodiment, the propagation delay estimation refresh periodicity is a function of an accurate reference time refresh from the access node to the wireless communication device, a periodicity of a generalized Precision Time Protocol (gPTP) message refresh from a TSN master clock to an associated TSN slave clock, or both. In another embodiment, the propagation delay estimation refresh periodicity configured independently from an upper layer reference time refresh. In one embodiment, the semi-persistent reference signal has an offset value relative to the propagation delay estimation refresh periodicity. In one embodiment, the semi-persistent uplink reference signal has an associated validity period.

In one embodiment, the one or more uplink reference signals for enhanced timing estimation comprise a periodic reference signal. In one embodiment, a periodicity of the periodic reference signal is a function of a propagation delay estimation refresh periodicity. In one embodiment, the semi-persistent reference signal has an offset value relative to the propagation delay estimation refresh periodicity.

In one embodiment, the message is a timing advance adjustment Medium Access Control (MAC) Control Element (CE) or a Radio Resource Control (RRC) message.

Corresponding embodiments of a wireless communication device are also disclosed. In one embodiment, a wireless communication device is adapted to transmit, to an access node, a signal for enhanced uplink timing estimation, wherein the signal occupies more or separate physical resources as compared to a corresponding signal transmitted for a purpose other than enhanced uplink timing estimation. The wireless communication device is further adapted to receive, from the access node, a message comprising timing-related information or clock time, responsive to transmitting the signal for enhanced uplink timing estimation.

In one embodiment, a wireless communication device comprises a radio interface and one or more processors associated with the radio interface. The one or more processors are configured to cause the wireless communication device to transmit, to an access node, a signal for enhanced uplink timing estimation, wherein the signal occupies more or separate physical resources as compared to a corresponding signal transmitted for a purpose other than enhanced uplink timing estimation. The one or more processors are further configured to cause the wireless communication device to receive, from the access node, a message comprising timing-related information or clock time, responsive to transmitting the signal for enhanced uplink timing estimation.

Embodiments of a method performed by an access node are also disclosed. In one embodiment, a method performed by an access node comprises receiving, from a wireless communication device, a signal for enhanced uplink timing estimation, wherein the signal for enhanced uplink timing estimation occupies more or separate physical resources as compared to a corresponding signal for a purpose other than enhanced uplink timing estimation. The method further comprises deriving timing-related information based on the signal for enhanced uplink timing estimation and transmitting, to the wireless communication device, a message comprising timing-related information or clock time, responsive to transmitting the signal for enhanced uplink timing estimation.

Corresponding embodiments of an access node are also disclosed. In one embodiment, an access node is adapted to receive, from a wireless communication device, a signal for enhanced uplink timing estimation, wherein the signal for enhanced uplink timing estimation occupies more or separate physical resources as compared to a corresponding signal for a purpose other than enhanced uplink timing estimation. The access node is further adapted to derive timing-related information based on the signal for enhanced uplink timing estimation and transmit, to the wireless communication device, a message comprising timing-related information or clock time, responsive to transmitting the signal for enhanced uplink timing estimation.

In one embodiment, an access node comprises one or more processors configured to cause the access node to receive, from a wireless communication device, a signal for enhanced uplink timing estimation, wherein the signal for enhanced uplink timing estimation occupies more or separate physical resources as compared to a corresponding signal for a purpose other than enhanced uplink timing estimation. The one or more processors are further configured to cause the access node to derive timing-related information based on the signal for enhanced uplink timing estimation and transmit, to the wireless communication device, a message comprising timing-related information or clock time, responsive to transmitting the signal for enhanced uplink timing estimation.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows a use case where two UEs can be connected to different gNBs, thereby introducing the potential for increasing uncertainty compared to the case where each UE is connected to the same gNB.

FIG. 2 illustrates an example of a wireless communication network. Wireless communication devices can communicate with an access node.

FIG. 3 is a flowchart illustrating a method for time synchronization implemented in a communication system, in accordance with one embodiment.

FIG. 4 is a flowchart illustrating a method for time synchronization implemented in a communication system, in accordance with another embodiment.

FIG. 5 is a flowchart illustrating a method for time synchronization implemented in a communication system, in accordance with another embodiment.

FIG. 6 is a flowchart illustrating a method for time synchronization implemented in a communication system, in accordance with another embodiment.

FIG. 7 is a flowchart illustrating a method for time synchronization implemented in a communication system, in accordance with another embodiment.

FIG. 8 is a flowchart illustrating a method for time synchronization implemented in a communication system, in accordance with another embodiment.

FIG. 9 illustrates a processor-based implementation of a network node which may be used for implementing the above-described embodiments.

FIG. 10 illustrates a processor-based implementation of a wireless communication device which may be used for implementing the above-described embodiments.

FIG. 11 illustrates an example of aperiodic SRS for time synchronization.

FIG. 12 illustrates an example of SP-SRS for time synchronization.

FIG. 13 illustrates another example of SP-SRS for time synchronization.

FIG. 14 illustrates another example of SP-SRS for time synchronization.

FIG. 15 illustrates an example of P-SRS for time synchronization.

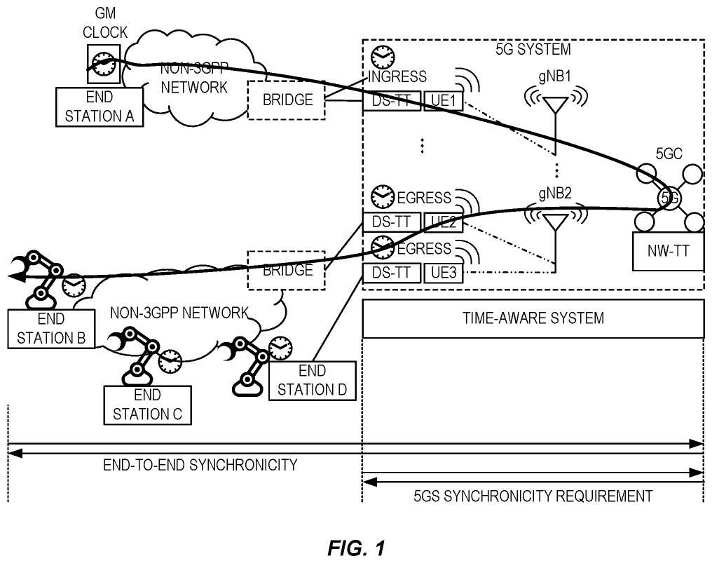

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments described herein, the term “coupled,” “connected,” and the like, may be used herein to indicate a connection, although not necessarily directly, and may include wired and/or wireless connections.

The term “wireless communication device” herein can be any type of device capable of communicating with a network node or another communication device over radio signals. The wireless communication device might be a radio communication device, target device, a user equipment (UE), a device to device (D2D) wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), USB dongles, Customer Premises Equipment (CPE), an Internet of Things (IOT) device, or a Narrowband IOT (NB-IOT) device, etc. The communication device might be a vehicle capable of supporting V2X communications.

Problems exist for the current solutions for Timing Sensitive Network (TSN) and Fifth Generation System (5GS) interworking. More specifically, in TSN network, a more accurate time offset estimation is required for clock synchronization.

In Third Generation Partnership Project (3GPP) New Radio (NR) up to NR Release 16, the Timing Advance (TA) estimated based on the Physical Random Access Channel (PRACH) may have a detection time error larger than the requirement of maximum time error for TSN, which makes the uplink timing at the next generation NodeB (gNB) side not as synchronized as required by the TSN. This issue mainly happens in low band when a small subcarrier spacing (SCS) is applied as the number of Physical Resource Blocks (PRBs) used by one PRACH preamble transmission is fixed to be 12 PRBs. Thus, the PRACH bandwidth is smaller when a smaller SCS is used. This leads to larger detection error since the detection error is approximately the inverse of the uplink signal bandwidth.

Thus, a new PRACH design is needed for clock synchronization, and whether and how to use the dedicated or common PRACH resource are also needed.

Furthermore, to use signals other than PRACH for time synchronization, different resource allocations of reference signals are required to meet the requirement for TSN specific time offset estimation.

The present disclosure discloses embodiments on improving the time estimation accuracy to ensure the uplink synchronization in a TSN by using enhanced PRACH with common PRACH resource configuration or dedicated PRACH resource configuration for time synchronization, using PRACH mask for determining the PRACH resource for clock synchronization, and modified PRACH configuration for clock synchronization. The present disclosure also discloses embodiments on improving the time estimation accuracy to ensure the uplink synchronization in a TSN by using signals other than PRACH for time synchronization, e.g., Aperiodic Sounding Reference Signal (SRS), Semi-persistent SRS and Periodic SRS. The present disclosure also discloses embodiments on improving the time estimation accuracy to ensure the uplink synchronization in a TSN by prioritizing the PRACH power ramping when doing reattempt for TSN.

In the discussion below, it is assumed that the wireless communication device, e.g., the User Equipment (UE), is a node for determining the clock time for itself, with signaling provided by an access node, e.g., enhanced NodeB (eNB) or gNB, to assist the communication device. Hence, the access node may send time information (e.g., absolute timing advance, timing advance adjustment, propagation delay information) to the communication device.

It is understood that the same methodology can be modified/adapted such that the access node is a node for determining the clock time for the wireless communication device. In this case, the access node may estimate the propagation delay for the wireless communication device and take this into account before sending the reference time to wireless communication device, e.g., via a UE-specific signaling (dedicated Radio Resource Control (RRC) signaling, or Medium Access Control (MAC) Control Element (CE) in the MAC Protocol Data Unit (PDU), or Layer 1 (L1) physical layer signaling). It is understood that the procedures described below can be easily adapted.

In the discussion below, it is assumed that the accurate reference time delivery and its associated propagation delay compensation estimation and compensation is for the purpose of providing accurate time stamping clock in the TSN time synchronization procedure. More precisely, it is used for the TSN time synchronization procedure which requires very accurate synchronization on the Uu interface, for example, with an accuracy of 100 nanoseconds (ns) or even lower. However, embodiments below can be independently utilized to provide, e.g., timing source (alternative for Global Positioning System (GPS) clock) for UE, delivering of the local clock to the UE, and etc.

Any other applications that require accurate clock synchronization between two nodes in a network can use the embodiments of the present disclosure as well, i.e. “TSN” term mentioned in the embodiments can be replaced by other similar network or use case as well.

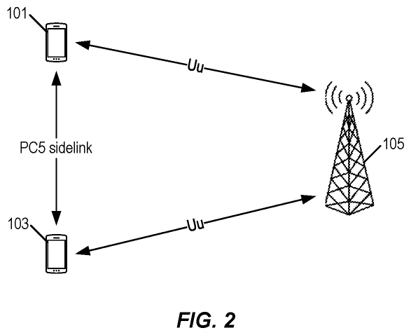

FIG. 2 illustrates an example of a wireless communication network. Wireless communication devices (e.g., user equipments (UEs)) 101 and 103 can communicate with an access node 105 (e.g., eNB or gNB). The wireless communication devices 101 and 103 communicates with the access node 105 over the Uu physical interface.

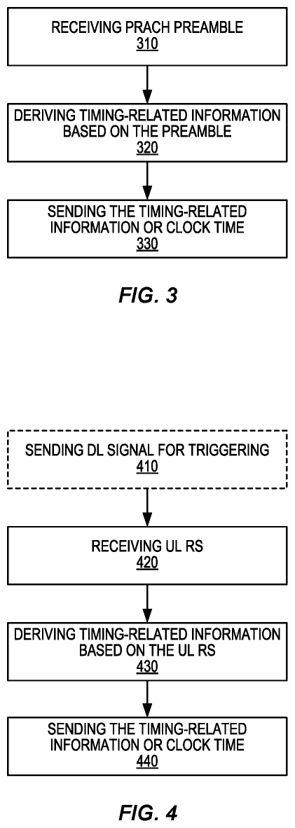

FIG. 3 is a flowchart illustrating a method for time synchronization implemented in a communication system, in accordance with one embodiment. The communication system includes a network node and a wireless communication device and may be the one described with reference to FIG. 2.

At step 310, the access node 105 receives a PRACH preamble for enhancing timing detection from the wireless communication device 101. In the present embodiment, transmission of the preamble for the enhancing timing detection occupies more or separate physical resources, e.g., bandwidth, as compared to normal level or one without the purpose of enhancing timing detection, e.g., for the purposes of random access and normal timing detection. Optionally, the physical resources for the transmission of the preamble for enhancing timing detection are shared by all wireless communication devices in a cell associated with the access node, i.e., wireless communication devices 101 and 103 in FIG. 2.

At step 320, the access node 105 derives timing-related information based on the preamble for enhancing timing detection. Optionally, the timing-related information is at least one of absolute timing advance (TA), TA adjustment, and propagation delay (PD).

At step 330, the access node 105 sends the timing-related information or clock time for the wireless communication device determined based on the timing-related information to the wireless communication device 101.

In the present embodiment, the timing-related information may be included in a TA command transmitted to the wireless communication device 101. Preferably, the TA command is signaled with a granularity smaller or finer than a granularity for normal transmission timing adjustment for Physical Uplink Control Channel (PUCCH)/Physical Uplink Shared Channel (PUSCH)/Sounding Reference Signal (SRS).

In the present embodiment, Random Access Channel (RACH) configuration is performed prior to step 310. The RACH configuration specifies how a wireless communication device within the cell associated with the access node 105 performs PRACH transmission. Optionally, the RACH configuration is cell-specific and common to all wireless communication devices in the cell associated with the access node 105.

Optionally, according to the RACH configuration, the preamble for enhancing timing detection is different from one for a use case of non-TSN, and a portion of PRACH resources in the cell associated with the access node 105 are reserved for the transmission of the preamble for enhancing timing detection.

In an illustrative example, the wireless communication device 101 is in a RRC CONNECTED State. Prior to step 310, the access node 105 triggers a RACH procedure by Physical Downlink Control Channel (PDCCH) including Downlink Control Information (DCI) format specifying which PRACH occasion(s) are configured for the enhancing timing detection. Thus, at step 310, the wireless communication device 101 transmits the preamble for enhancing timing detection by dedicated PRACH resources.

Optionally, according to the RACH configuration, the dedicated PRACH resources are shared by all wireless communication devices or allowable to be used by a group of wireless communication devices in the cell associated with the access node 105.

Optionally, according to the RACH configuration, a PRACH mask signaled by the DCI is used for filtering the dedicated PRACH resources or determining a common PRACH resources for enhancing timing detection.

Optionally, the RACH configuration for clock synchronization has a configurable time domain modification.

Optionally, according to the RACH configuration, a higher power ramping step and/or a smaller back-off time are used for enhancing timing detection.

FIG. 4 is a flowchart illustrating a method for time synchronization implemented in a communication system, in accordance with another embodiment. The communication system includes a network node and a wireless communication device and may be the one described with reference to FIG. 2.

At step 410, the access node 105 sends to the wireless communication device 101 a downlink (DL) signal to trigger Uplink (UL) Reference Signal (RS) transmission.

At step 420, the access node 105 receives a UL RS from the wireless communication device 101. Optionally, the UL RS is one selected from a group consisting of wideband or enhanced Sounding Reference Signal (SRS), Demodulation Reference Signal (DMRS), and Phase Tracking Reference Signal (PTRS).

At step 430, the access node 105 derives timing-related information based on the UL RS. Optionally, the timing-related information is at least one of absolute timing advance, TA adjustment, and propagation delay.

At step 440, the access node 105 sends the timing-related information or clock time for the wireless communication device determined based on the timing-related information to the wireless communication device.

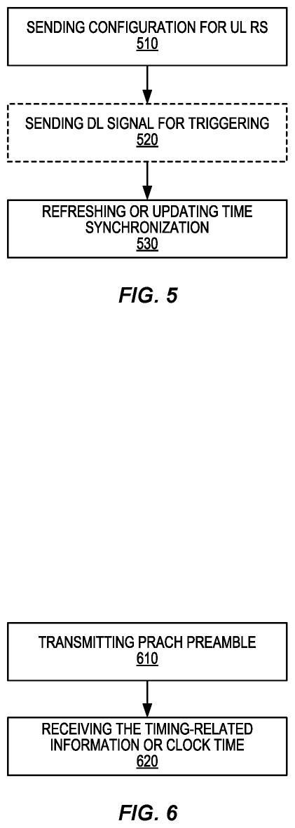

FIG. 5 is a flowchart illustrating a method for time synchronization implemented in a communication system, in accordance with another embodiment. The communication system includes a network node and a wireless communication device and may be the one described with reference to FIG. 2.

At step 510, the access node 105 sends to the wireless communication device 101 configuration for UL RS according to which the wireless communication device 101 carries out multiple UL RS transmission.

Optionally, the UL RS is one selected from a group consisting of wideband or enhanced Sounding Reference Signal (SRS), Demodulation Reference Signal (DMRS) and Phase Tracking Reference Signal (PTRS).

Optionally, the configuration is RRC configuration specifying a periodicity of the multiple UL RS transmission and an offset for the periodicity of the multiple UL RS transmission in relation to Propagation Delay (PD) refresh periodicity.

Optionally, the configuration is RRC configuration specifying a periodicity of the multiple UL RS transmission, a validity period for the multiple UL RS transmission and an offset for the periodicity of the multiple UL RS transmission in relation to Propagation Delay (PD) refresh periodicity.

At step 520, the access node 105 sends to the wireless communication device 101 a downlink (DL) signal to trigger the multiple UL RS transmission.

At step 530, the access node 105 refreshes or updates time synchronization in the following manner:
each time when receiving one UL RS from the wireless communication device 101 or a predetermined number of UL RSs from the wireless communication device 101, the access node 105 derives a respective timing-related information based on the received UL RS(s) and then sends the respective timing-related information or clock time for the wireless communication device determined based on the respective timing-related information to the wireless communication device 101.

Optionally, the timing-related information is at least one of absolute timing advance, TA adjustment, and propagation delay.

In the present embodiment, step 520 is optional. That is, the multiple UL RS transmission can be either triggered by a signal from network side, e.g., the DL signal from the access node or triggered spontaneously at the wireless communication device according to the configuration sent to the wireless communication device at step 510.

FIG. 6 is a flowchart illustrating a method for time synchronization implemented in a communication system, in accordance with one embodiment. The communication system includes a network node and a wireless communication device and may be the one described with reference to FIG. 2.

At step 610, the wireless communication device 101 transmits a Physical Random Access Channel (PRACH) preamble for enhancing timing detection from the access node 105. In the present embodiment, transmission of the preamble for the enhancing timing detection occupies more or separate physical resources, e.g., bandwidth, as compared to normal level, e.g., for the purposes of random access and normal timing detection. Optionally, the physical resources for the transmission of the preamble for enhancing timing detection are shared by all wireless devices in a cell associated with the access node, i.e., UEs 101 and 103 in FIG. 2.

At step 620, the wireless communication device 101 receives from the access node 105 timing-related information derived based on the preamble for enhancing timing detection or clock time for the wireless communication device determined based on the timing-related information. Optionally, the timing-related information is at least one of absolute timing advance (TA), TA adjustment, and propagation delay (PD).

In the present embodiment, the timing-related information may be included in a TA command transmitted to the wireless communication device 101. Preferably, the TA command is signaled with a granularity smaller or finer than a granularity for normal transmission timing adjustment for Physical Uplink Control Channel (PUCCH)/Physical Uplink Shared Channel (PUSCH)/Sounding Reference Signal (SRS).

In the present embodiment, Radio Access Channel (RACH) configuration is performed prior to step 610. The RACH configuration specifies how a wireless communication device within the cell associated with the access node 105 performs PRACH transmission. Optionally, the RACH configuration is cell-specific and common to all wireless communication devices in the cell associated with the access node 105.

Optionally, according to the RACH configuration, the preamble for enhancing timing detection is different from one for a use case of non-Time Sensitive Network (TSN), and a portion of PRACH resources in the cell associated with the access node 105 are reserved for the transmission of the preamble for enhancing timing detection.

In an illustrative example, the wireless communication device 101 is in a RRC CONNECTED State. Prior to step 610, the wireless communication device 101 receives from the access node 105a control signal via PDCCH to trigger a RACH procedure. The control signal includes Downlink Control Information (DCI) format specifying which PRACH occasion(s) are configured for the enhancing timing detection. Thus, at step 610, the wireless communication device 101 transmits the preamble for enhancing timing detection by dedicated PRACH resources.

Optionally, according to the RACH configuration, the dedicated PRACH resources are shared by all wireless communication device or allowable to be used by a group of wireless devices in the cell associated with the access node 105.

Optionally, according to the RACH configuration, a PRACH mask signaled by the DCI is used for filtering the dedicated PRACH resources or determining a common PRACH resources for enhancing timing detection.

Optionally, the RACH configuration for clock synchronization has a configurable time domain modification.

Optionally, according to the RACH configuration, a higher power ramping step and/or a smaller back-off time are used for enhancing timing detection.

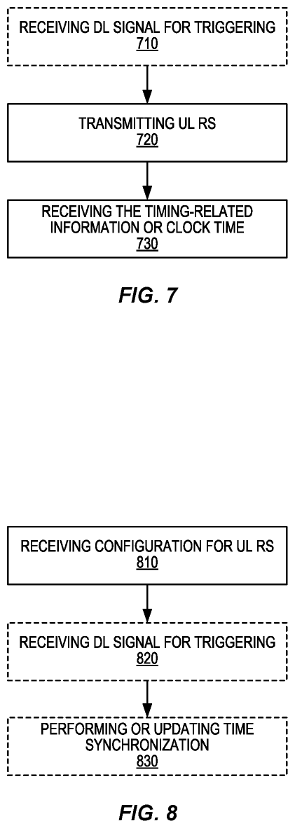

FIG. 7 is a flowchart illustrating a method for time synchronization implemented in a communication system, in accordance with another embodiment. The communication system includes a network node and a wireless communication device and may be one described with reference to FIG. 2.

At step 710, the wireless communication device 101 receives from the access node 105 a downlink (DL) signal to trigger the UL RS transmission.

At step 720, the wireless communication device 101 transmits a UL RS to the access node 105. Optionally, the UL RS is one selected from a group consisting of wideband or enhanced Sounding Reference Signal (SRS), Demodulation Reference Signal (DMRS) and Phase Tracking Reference Signal (PTRS).

At step 730, the wireless communication device 101 receives from the access node 105 timing-related information derived based on the UL RS or clock time for the wireless communication device determined based on the timing-related information. Optionally, the timing-related information is at least one of absolute timing advance, TA adjustment, and propagation delay.

FIG. 8 is a flowchart illustrating a method for time synchronization implemented in a communication system, in accordance with another embodiment. The communication system includes a network node and a wireless communication device and may be one described with reference to FIG. 2.

At step 810, the wireless communication device 101 receives from the access node 105 configuration for UL RS according to which the wireless communication device 101 carries out multiple UL RS transmission.

Optionally, the UL RS is one selected from a group consisting of wideband or enhanced Sounding Reference Signal (SRS), Demodulation Reference Signal (DMRS) and Phase Tracking Reference Signal (PTRS).

Optionally, the configuration is RRC configuration specifying a periodicity of the multiple UL RS transmission and an offset for the periodicity of the multiple UL RS transmission in relation to Propagation Delay (PD) refresh periodicity.

Optionally, the configuration is RRC configuration specifying a periodicity of the multiple UL RS transmission, a validity period for the multiple UL RS transmission and an offset for the periodicity of the multiple UL RS transmission in relation to Propagation Delay (PD) refresh periodicity.

At step 820, the wireless communication device 101 receives from the access node 105 a downlink (DL) signal to trigger the multiple UL RS transmission.

At step 830, the wireless communication device 101 performs or updates time synchronization according to the configuration in the following manner:
each time after transmitting one UL RS to the access node 105 or a predetermined number of UL RSs to the access node 105, the wireless communication device 101 receives from the access node 105 a respective timing-related information derived based on the transmitted UL RS(s) or clock time for the wireless communication device determined based on the respective timing-related information.

Optionally, the timing-related information is at least one of absolute timing advance, TA adjustment, and propagation delay.

In the present embodiment, step 820 is optional. That is, the multiple UL RS transmission can be either triggered by a signal from network side, e.g., the DL signal from the access node or triggered spontaneously at the wireless communication device according to the configuration received from the access node at step 810.

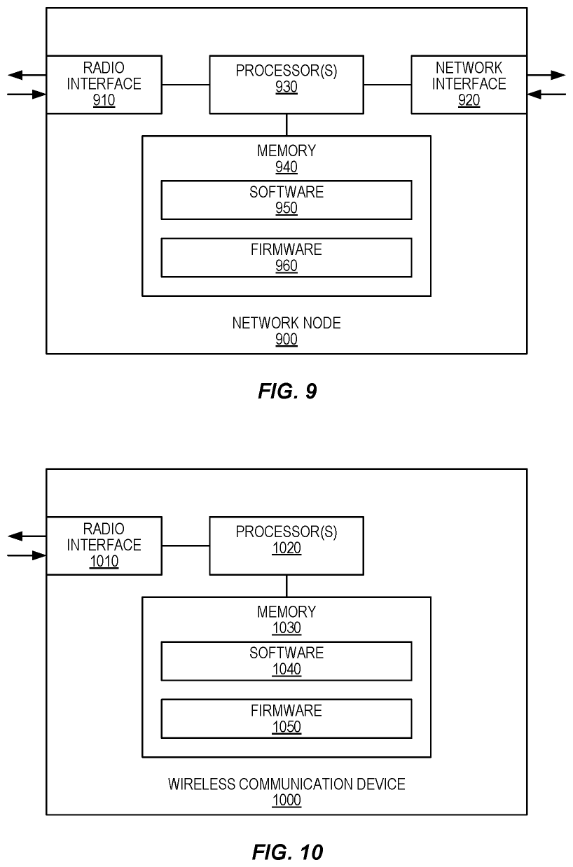

FIG. 9 illustrates a processor-based implementation of a network node which may be used for implementing the above-described embodiments. For example, the structures as illustrated in FIG. 9 may be used for implementing the concepts in any of the above-mentioned access nodes.

As illustrated, the node 900 may include one or more radio interfaces 910. The radio interface(s) 910 may for example be based on the NR technology or the LTE technology. The radio interface(s) 910 may be used for controlling wireless communication devices, such as any of the above-mentioned UEs. In addition, the node 900 may include one or more network interfaces 920. The network interface(s) 920 may for example be used for communication with one or more other nodes of the wireless communication network.

Further, the node 900 may include one or more processors 930 coupled to the interfaces 910, 920 and a memory 940 coupled to the processor(s) 930. By way of example, the interfaces 910, 920, the processor(s) 930, and the memory 940 could be coupled by one or more internal bus systems of the node 900. The memory 940 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 940 may include software 950 and/or firmware 960. The memory 940 may include suitably configured program code to be executed by the processor(s) 930 so as to implement the above-described functionalities for time synchronization, such as explained in connection with FIGS. 3 to 5.

It is to be understood that the structure as illustrated in FIG. 9 is merely schematic and that the node 900 may actually include further components which, for the sake of clarity, have not been illustrated, e.g., further interfaces, such as a dedicated management interface, or further processors. Also, it is to be understood that the memory 940 may include further program code for implementing known functionalities of an eNB or gNB.

According to some embodiments, also a computer program may be provided for implementing functionalities of the node 900, e.g., in the form of a physical medium storing the program code and/or other data to be stored in the memory 940 or by making the program code available for download or by streaming.

FIG. 10 illustrates a processor-based implementation of a wireless communication device which may be used for implementing the above-described embodiments.

As illustrated, the wireless communication device 1000 includes one or more radio interfaces 1010. The radio interface(s) 1010 may for example be based on the NR technology or the LTE technology.

Further, the wireless communication device 1000 may include one or more processors 1020 coupled to the radio interface(s) 1010 and a memory 1030 coupled to the processor(s) 1020.

By way of example, the radio interface(s) 1010, the processor(s) 1020, and the memory 1030 could be coupled by one or more internal bus systems of the wireless communication device 1000. The memory 1030 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1030 may include software 1040 and/or firmware 1050. The memory 1030 may include suitably configured program code to be executed by the processor(s) 320 so as to implement the above-described functionalities for time synchronization, such as explained in connection with FIGS. 6 to 8.

It is to be understood that the structure as illustrated in FIG. 10 is merely schematic and that the wireless communication device 1000 may actually include further components which, for the sake of clarity, have not been illustrated, e.g., further interfaces, such as a dedicated management interface, or further processors. Also, it is to be understood that the memory 1030 may include further program code for implementing known functionalities of a UE.

According to some embodiments, also a computer program may be provided for implementing functionalities of the wireless communication device 1000, e.g., in the form of a physical medium storing the program code and/or other data to be stored in the memory 1030 or by making the program code available for download or by streaming.

Further details appliable to the embodiments described above will now be described in the following sections.

### Section 1: RACH Procedure with Enhanced PRACH for Time Synchronization

In this section, the RACH procedure is used to send time advance related information from the gNB to the UE, where the PRACH used in the RACH procedure is enhanced for more accurate uplink timing estimation at the gNB.

The RACH procedure includes all variations, including 4-step RACH and 2-step RACH, contention-free-based RACH and contention-based RACH. The timing advance (TA) related information can be absolute timing advance and incremental timing advance. The TA related information is carried in a random access response (RAR) message, where the RAR message format includes all variants for the corresponding RACH procedure, i.e., RAR for 4-step RACH procedure, fallbackRAR and successRAR MAC subPDU for 2-step RACH.

The enhanced PRACH is specifically designated for improved timing detection, and different from the PRACH used for normal data communication, e.g., random access and normal timing detection. In a preferred embodiment, the enhanced PRACH occupies larger bandwidth than PRACH for normal data communication, for a given value of PUSCH SCS.

With the enhanced PRACH for timing detection, the timing information generated by gNB can be signaled with a smaller or finer granularity so as to achieve an improved timing accuracy. For example, if the enhanced PRACH is used in the uplink, then the timing advance command is associated with a granularity g1, where g1<g0. Here g0 is the granularity defined for normal transmission timing adjustment of PUCCH/PUSCH/SRS. For an uplink SCS of 2μ*15 kHz, the existing timing advance command granularity g0 is g0=16*64/2μ for NR Rel-15/Rel-16. In contrast, the exemplary values of g1, g1<g0, include: g1=K/2μ, where integer K is preferably a power of 2 value, and K<16*64. Exemplary values of K include: K={8*64, 4*64, 2*64, 64, 32, 16}.

Denote the timing advance value carried in RAR as TA. The absolute timing advance value is NTA=TA*g1. The propagation delay between the gNB and the UE can be estimated as:

$$PD = \frac{1}{2} * {N}_{TA} * {T}_{c} = \frac{1}{2} * {T}_{A} * {g}_{1} * {T}_{c} = \frac{1}{2} * {T}_{A} * K * {T}_{c} / {2}^{μ} \qquad ( 1 )$$

Tc is the basic timing unit defined in TS 38.211, T_{c}=1/(Δfₘₐₓ·N_{f}) where Δfmax=480*103 Hz and Nf=4096.

### Section 1-1: Enhanced RACH Procedure for Common PRACH Resource:

Optionally, the RACH procedure used for time synchronization purpose is the same RACH as the initial attachment and uses the common PRACH resource shared by all UEs in the cell.

Optionally, the RACH configuration is cell-specific and common to all UEs in cell, i.e., the higher layer configuration is provided by RACH-ConfigCommon for 4-step RACH, and provided by RACH-ConfigCommonTwoStepRA in MsgA-ConfigCommon for 2-step RACH. With this method, the RACH resource overhead is minimized to support more accurate timing synchronization in TSN.

Optionally, different preambles are used to differentiate TSN usage and non-TSN usage in a way that only TSN usage can use certain preambles. In addition, the same UE can access both the preambles reserved for TSN usage and reserved for non-TSN usage. The UE uses the preambles reserved for TSN usage, if the upper layer in the UE indicates that, e.g., the TSN time synchronization or the TSN protocol was started in its software stack. Otherwise, the UE uses the preambles reserved for non-TSN usage. In this variant, which preambles are used for TSN usage is implicit, for example, UE selects (by its implementation) the preamble that gives the better timing estimation at the gNB (e.g., longer length, larger bandwidth etc.) or network indicates so in the non-access-stratum (NAS) messages.

Optionally, the gNB partitions the common PRACH resource of one cell into two sets, e.g., set A and set B. The set A is reserved for TSN usage and the set B is reserved for non TSN-usage. The gNB configures only the set A to one set of UEs in the cell (which requires accurate reference time delivery for TSN) and the set B to another set of UEs in the cell (which does not require accurate reference time delivery).

Optionally, the RACH configuration is cell-specific and common to all UEs in a cell, but the PRACH resources are explicitly and separately configured for propagation delay compensation used in accurate timing delivery for the purpose of, e.g., time synchronization in the TSN. With this method, a more flexible PRACH/MsgA configuration can be configured for more accurate time synchronization in TSN.

To implement this change in the spec, as one example, a separate RRC field/IE is configured, i.e., RACH-ConfigCommonSync for 4-step RACH, and provided by RACH-ConfigCommonTwoStepRASync in MsgA-ConfigCommonSync for 2-step RACH.

| | |
|---|---|
| BWP-UplinkCommon : := | SEQUENCE { |
| genericParameters | BWP, |
| rach-ConfigCommon | SetupRelease { RACH-ConfigCommon } |

OPTIONAL, -- Need M

| | |
|---|---|
| pusch-ConfigCommon | SetupRelease { PUSCH-ConfigCommon } |

OPTIONAL, -- Need M

| | |
|---|---|
| pucch-ConfigCommon | SetupRelease { PUCCH-ConfigCommon } |

```
OPTIONAL, -- Need M
      ...,
  [[
```

| | |
|---|---|
| rach-ConfigCommonIAB-r16 | SetupRelease { RACH-ConfigCommon } |

OPTIONAL, -- Need M

| | |
|---|---|
| useInterlacePUCCH-PUSCH-r16 | ENUMERATED { enabled } |

OPTIONAL, -- Need R

| | |
|---|---|
| msgA-ConfigCommon-r16 | SetupRelease { MsgA-ConfigCommon-r16 } |

```
OPTIONAL -- Cond SpCellOnly2
    ]]
    [[
```

| | |
|---|---|
| rach-ConfigCommonSync-r17 | SetupRelease { RACH-ConfigCommon } |

OPTIONAL, -- Need M

| | |
|---|---|
| msgA-ConfigCommonSync-r17 | SetupRelease { MsgA-ConfigCommon-r16 |

} OPTIONAL -- Cond SpCellOnly2
]]

Optionally, the PRACH is triggered by a downlink signal (for example, DCI or PDCCH order transmitted in the DCI), while the PRACH resources is cell common.

Section 1-2: Dedicated PRACH Resource with Enhanced PRACH:

Optionally, the RACH procedure used for the time synchronization purpose is triggered when the radio link is already established, i.e., not the same RACH as initial attachment and the UE is in the RRC_CONNECTED state. In a preferred embodiment, the RACH procedure with enhanced PRACH is triggered by PDCCH. The DCI format carried by the PDCCH contains a field that points to PRACH occasion(s) that are configured for enhanced PRACH, which is enhanced for uplink timing detection and different from the PRACH for initial access.

Optionally, the RACH procedure with enhanced PRACH is triggered periodically. E.g., the PRACH transmission can be similar to configured grant based PUSCH transmission.

Optionally, the enhanced PRACH is not provided by a cell-specific signaling shared by all UEs in the cell. Instead, the enhanced PRACH is provided by a UE specific signaling, e.g., the RRC configuration is sent in a UE-specific RRC message, RACH-ConfigDedicated for instance. Alternatively, the enhanced PRACH is provided by a group-specific signaling, e.g., the RRC configuration RACH-ConfigDedicated is sent to, and shared by, a group of TSN UEs.

An example is provided below regarding the dedicated PRACH configuration for TSN in RACH-ConfigDedicated IE.

| RACH-ConfigDedicated ::= | | SEQUENCE { |
|---|---|---|
| cfra | CFRA | OPTIONAL, -- Need |

S

| | | |
|---|---|---|
| ra-Prioritization | RA-Prioritization | OPTIONAL, -- Need |

```
N
    ...,
    [[
```

| | |
|---|---|
| ra-PrioritizationTwoStep-r16 | RA-Prioritization |

OPTIONAL, -- Need N

| | |
|---|---|
| cfra-TwoStep-r16 | CFRA-TwoStep-r16 |

OPTIONAL --Need S
]]

| | | |
|---|---|---|
| cfraSync | CFRA | OPTIONAL, -- |

Need S

| | | |
|---|---|---|
| ra-PrioritizationSync | RA-Prioritization | OPTIONAL, -- |

```
Need N
    ...,
    [[
```

| | |
|---|---|
| ra-PrioritizationTwoStepSync-r17 | RA-Prioritization |

OPTIONAL, -- Need N

| | |
|---|---|
| cfra-TwoStepSync-r17 | CFRA-TwoStep-r16 |

```
OPTIONAL -- Need S
  ]]
  }
```

### Section 1-3: PRACH Mask to Filter the PRACH Resource for Clock Synchronization:

Optionally, when dedicated PRACH resources are configured, a new RACH mask index values can be defined for clock synchronization in TSN compared to NR Rel-16.

The PRACH mask index can be signaled by a DCI format when a PDCCH order is used to trigger a PRACH transmission for clock synchronization. For example, the 4-bit “PRACH Mask index” field in DCI format 1_0).

Let J be the PRACH occasion index. The variable J is an integer with value starting from 1. The maximum value of variable J depends on the time/frequency/format configuration of PRACH. As an example, two new sets of allowed PRACH occasions of SSB can be defined via previously reserved value 11 and 12 of PRACH Mask index, as shown in Table 4 below.

TABLE 1
PRACH Mask Index values, with new entries

| PRACH Mask | |
|---|---|
| Index/ | |
| msgA-SSB- | |
| SharedRO- | |
| MaskIndex | Allowed PRACH occasion(s) of SSB |
| 0 | All |
| 1 | PRACH occasion index 1 |
| 2 | PRACH occasion index 2 |
| 3 | PRACH occasion index 3 |
| 4 | PRACH occasion index 4 |
| 5 | PRACH occasion index 5 |
| 6 | PRACH occasion index 6 |
| 7 | PRACH occasion index 7 |
| 8 | PRACH occasion index 8 |
| 9 | Every even PRACH occasion |
| 10 | Every odd PRACH occasion |
| 11 | Mod(J, 4) = 0 |
| 12 | Mod(J, 4) = 1 |
| 13 | Mod(J, 4) = 2 |
| 14 | Mod(J, 4) = 3 |
| 15 | Reserved |

Optionally, a PRACH mask is introduced for determine a common PRACH resource for clock synchronization.

Section 1-4: PRACH Configuration with Time Domain Modification for Clock Synchronization:

Optionally, the PRACH configuration for clock synchronization is based on the PRACH configuration for clock synchronization but with a configurable time domain modification.

The configuration is done by RRC and the modification includes, for example,

For the clock synchronization of the UE with the network node (e.g., gNB), the following applies:
if the higher-layer parameter prach-ConfigurationPeriodScalingSync is configured, the variable x used in n_“f” “mod” x=y of Tables 6.3.3.2-2 to 6.3.3.2-4 shall be replaced by x_“sync”, where x_“sync”=ax and a is given by the higher-layer parameter prach-ConfigurationPeriodScalingSync;
if the higher-layer parameter prach-ConfigurationFrameOffsetSync is configured, the variable y used in n_“f” “mod” x=y of Tables 6.3.3.2-2 to 6.3.3.2-4 shall be replaced by y_“sync”=(y+Δy)“mod”x where Δy is given by the higher-layer parameter prach-ConfigurationFrameOffsetSync, and x is the value used in n_“f” mod x=y;
if the higher-layer parameter prach-ConfigurationSOffsetSync is configured, the subframe number s_“n” from Tables 6.3.3.2-2 to 6.3.3.2-3 and the slot number s_“n” from Table 6.3.3.2-4 shall be replaced by (s_“n”+Δs)“mod”L where Δs∈{0, 1, . . . , L−1} is given by the higher-layer parameter prach-ConfigurationSOffsetSync, and L is the number of subframes in a frame when using Tables 6.3.3.2-2 to 6.3.3.2-3 and the number of slots in a frame for 60 KHz subcarrier spacing when using in Table 6.3.3.2-4.

The higher layer (e.g., RRC) parameters (prach-ConfigurationPeriodScalingSync, prach-ConfigurationFrameOffsetSync, prach-ConfigurationSOffsetSync) can be part of the IE RACH-ConfigGeneric or RACH-ConfigGenericTwoStepRA-r16.

The configuration can be sent to a UE in a cell-specific manner, i.e., the parameters are the same for all UEs in the same cell. For example, they can be included in information element RACH-ConfigCommon for 4-step RACH, and/or included in RACH-ConfigCommonTwoStepRA for two-step RACH. Alternatively, these higher layer parameters can be configured to specific TSN UEs with different values and transmitted in, e.g., RACH-ConfigDedicated.

Exemplary configurations of these parameters are illustrated below.

| | |
|---|---|
| RACH-ConfigGeneric ::= | SEQUENCE { |
| prach-Configuration Index | INTEGER (0..255), |
| msg1-FDM | ENUMERATED {one, two, |
| four, eight}, | |
| msg1-FrequencyStart | INTEGER |
| (0..maxNrofPhysicalResourceBlocks-1), | |
| zeroCorrelationZoneConfig | INTEGER (0..15), |
| preambleReceivedTargetPower | INTEGER (−202..−60), |
| preambleTransMax | ENUMERATED { n3, n4, n5, |
| n6, n7, n8, n10, n20, n50, n100, n200}, | |
| powerRampingStep | ENUMERATED { dB0, dB2, dB4, dB6}, |
| ra-ResponseWindow | ENUMERATED { sl1, sl2, sl4, sl8, |
| sl10, sl20, sl40, sl80}, | |
| ..., | |
| [[ | |
| prach-ConfigurationPeriodScaling-IAB-r16 | ENUMERATED |
| | {scf1, scf2, scf4, scf8, scf16, scf32, scf64} |
| OPTIONAL, -- Need R | |
| prach-ConfigurationFrameOffset-IAB-r16 | INTEGER (0..63) |
| OPTIONAL, -- Need R | |
| prach-ConfigurationSOffset-IAB-r16 | INTEGER (0..39) |
| OPTIONAL, -- Need R | |
| ra-ResponseWindow-v1610 | ENUMERATED { sl60, sl160} |
| OPTIONAL, -- Need R | |
| prach-ConfigurationIndex-v1610 | INTEGER (256..262) |
| OPTIONAL, -- Need R | |
| ]] | |
| [[ | |
| prach-ConfigurationPeriodScalingSync | ENUMERATED |
| {scf1, scf2, scf4, scf8, scf16, scf32, scf64} | OPTIONAL, -- Need R |
| prach-ConfigurationFrameOffsetSync | INTEGER (0..63) |
| OPTIONAL, -- Need R | |
| prach-ConfigurationSOffsetSync | INTEGER (0..39) |
| OPTIONAL, -- Need R | |
| ]] | |
| } | |

Section 1-5: A higher Priority PRACH Configuration for Clock Synchronization:

Higher priority PRACH configuration: a higher power ramping step and/or a smaller back-off time can be used for time sync in TSN. An example on how to implement this in RRC is shown below. A separate IE RA-PrioritizationTimeSync with more code points can be used.

| | |
|---|---|
| RA-Prioritization ::= | SEQUENCE { |
| powerRampingStepHighPriority | ENUMERATED { dB0, dB2, dB4, |
| dB6}, | |
| scalingFactorBI | ENUMERATED {zero, dot25, dot5, |
| dot 75} OPTIONAL, -- Need R | |
| ... | |
| } | |
| RA-PrioritizationTimeSync-r17 ::= | SEQUENCE { |
| powerRampingStepHighPriority-r17 | ENUMERATED { dB0, dB2, dB4, |
| dB6, dB8, dB10, spare1, spare2 }, | |
| scalingFactorBI-r17 ENUMERATED | {zero, dot125, dot25, dot375, |
| dot5, dot625, dot75, dot875} | |
| | OPTIONAL, -- Need R |
| ... | |
| } | |

The new IE can be used in any IEs that configure the RACH resource, for example, RACH-ConfigCommon for 4-step RA, RACH-ConfigCommonTwoStepRA for 2-step RA, RACH-ConfigDedicated for either 2-step or 4-step CFRA. One example is shown below:

| | |
|---|---|
| RACH-ConfigDedicated ::= | SEQUENCE { |
| cfra | CFRA OPTIONAL, -- Need S |
| ra-Prioritization | RA-Prioritization OPTIONAL, -- Need N |
| ..., | |
| [[ | |
| ra-PrioritizationTwoStep-r16 | RA-Prioritization OPTIONAL, |
| -- Need N | |
| cfra-TwoStep-r16 | CFRA-TwoStep-r16 OPTIONAL - |
| - Need S | |
| ]] | |
| [[ | |
| ra-PrioritizationTimeSync-r17 | RA-PrioritizationTimeSync-r17 |
| OPTIONAL, -- Need R | |
| ra-PrioritizationTimeSyncTwoStep-r17 | RA- |
| PrioritizationTimeSync-r17 | OPTIONAL -- Need R |
| ]] | |
| } | |

### Section 2: Other Uplink Reference Signal (Other than PRACH) Based Procedure for Time Synchronization

In this section, the procedure uses uplink reference signal (i.e., not PRACH) on the uplink for the gNB to estimate uplink timing. In one example, the uplink reference signal (RS) is an enhanced SRS. Other examples of uplink reference signal include demodulation reference signal (DMRS), Phase Tracking RS (PTRS). The discussion below assumes SRS, while DMRS and PTRS can be used with similar procedure.

### Section 2-1: Aperiodic SRS Based Procedure:

The SRS can be aperiodic SRS (A-SRS). For each time instance the PD estimation is needed, the following procedure is applied:
Step (a): The gNB sends a downlink signal to trigger aperiodic SRS transmission on the uplink.
Step (b): The triggered aperiodic SRS is sent from UE to gNB;
Step (c): The gNB performs uplink timing detection based on the transmitted A-SRS, and derives the timing information;
Step (d): The gNB sends the timing information to the UE with either a timing advance adjustment MAC CE (e.g., time synchronization command (TSC) MAC CE) or RRC message containing the accurate reference time with propagation delay pre-compensated.

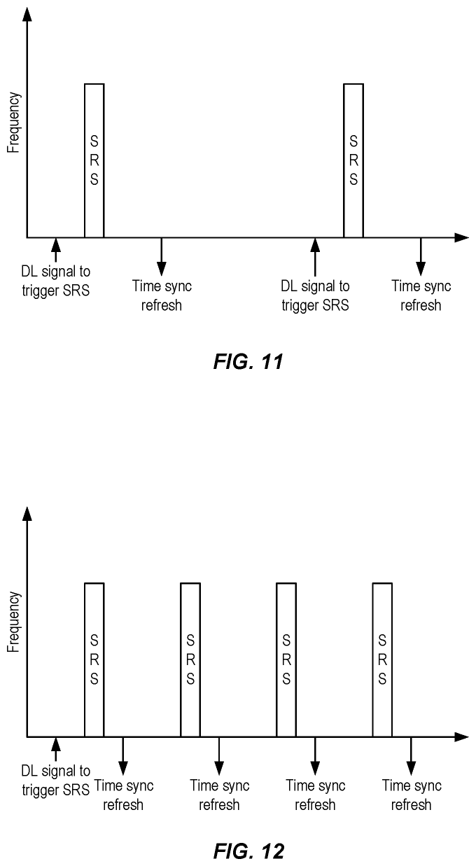

If PD estimation is needed repeatedly (e.g., to refresh PD estimation from time to time, the above procedure is applied repeatedly, including the downlink signal to trigger the A-SRS, as shown in FIG. 11. Preferably the gNB has configured this A-SRS to be a wideband SRS, which is defined for time sync purpose.

The below is examples on SRS resources configuration for time sync purpose in the RRC specification. In the first example, a specific SRS resource set for time sync is configured.

| | |
|---|---|
| SRS-Config ::= | SEQUENCE { |

```
    ----- Unchanged parts omitted -----
    ]]
    [[
```

| | |
|---|---|
| srs-timeSyncResourceSetToAddModList-r17 | SEQUENCE |

(SIZE (1..maxNrofSRS-TimeSyncResourceSets-r17)) OF SRS-

| | |
|---|---|
| TimeSyncResourceSet-r17 | OPTIONAL, -- Need N |
| srs-timeSyncResourceToAddModList-r17 | SEQUENCE |

(SIZE (1..maxNrofSRS-TimeSyncResources-r17)) OF SRS-

| | |
|---|---|
| TimeSyncResource-r17 | OPTIONAL -- Need N |
| srs-timeSyncResourceToReleaseList-r17 | SEQUENCE |

(SIZE (1..maxNrofSRS-TimeSyncResources-r17)) OF SRS-

| | |
|---|---|
| TimeSyncResourceId-r17 | OPTIONAL, -- Need N |

]]
}

| | |
|---|---|
| SRS-TimeSyncResourceSet-r17 ::= | SEQUENCE { |
| srs-TimeSyncResourceSetId-r17 | SRS- |

TimeSyncResourceSetId-r17,

| | |
|---|---|
| srs-TimeSyncResourceIdList-r17 | SEQUENCE (SIZE (1..maxNrofSRS- |

ResourcesPerSet))

OF SRS-TimeSyncResourceId-r17

OPTIONAL, -- Cond Setup

| | |
|---|---|
| resourceType-r17 | CHOICE { |
| aperiodic-r17 | SEQUENCE { |

aperiodicSRS-ResourceTriggerList-r17

```
        SEQUENCE (SIZE (1..maxNrofSRS-TriggerStates-1))
        OF INTEGER (1..maxNrofSRS-TriggerStates-1)
```

OPTIONAL, -- Need M

...

},

| | |
|---|---|
| semi-persistent-r17 | SEQUENCE { |

...

},

| | |
|---|---|
| periodic-r17 | SEQUENCE { |

...

```
        }
    },
```

| | | |
|---|---|---|
| alpha-r17 | Alpha | OPTIONAL, -- Need S |
| p0-r17 | INTEGER (−202..24) | OPTIONAL, -- Cond Setup |

| | |
|---|---|
| pathlossReferenceRS-TimeSync-r17 | CHOICE { |
| ssb-Index | SSB-Index, |
| csi-RS-Index | NZP-CSI-RS- |

ResourceId

| | |
|---|---|
| } | OPTIONAL, -- Need M |

...
}

| | |
|---|---|
| SRS-TimeSyncResourceSetId-r17 ::= | INTEGER (0..maxNrofSRS- |

TimeSyncResourceSets-1-r17)

| | |
|---|---|
| SRS-TimeSyncResource-r17::= | SEQUENCE { |
| srs-TimeSyncResourceId-r17 | SRS-TimeSyncResourceId-r17, |
| transmissionComb-r17 | CHOICE { |
| n2-r17 | SEQUENCE { |
| combOffset-n2-r17 | INTEGER (0..1), |
| cyclicShift-n2-r17 | INTEGER (0..7) |

},

| | |
|---|---|
| n4-r17 | SEQUENCE { |
| combOffset-n4-16 | INTEGER (0..3), |
| cyclicShift-n4-r17 | INTEGER (0..11) |

},

| | |
|---|---|
| n8-r17 | SEQUENCE { |
| combOffset-n8-r17 | INTEGER (0..7), |
| cyclicShift-n8-r17 | INTEGER (0..5) |

```
    },
    ...
  },
```

| | |
|---|---|
| resourceMapping-r17 | SEQUENCE { |
| startTimeSyncition-r17 | INTEGER (0..13), |
| nrofSymbols-r17 | ENUMERATED {n1, n2, n4, n8, |

n12}
},

| | |
|---|---|
| freqDomainShift-r17 | INTEGER (0..268), |
| freqHopping-r17 | SEQUENCE { |
| c-SRS-r17 | INTEGER (0..63), |

```
    ...
  },
```

| | |
|---|---|
| groupOrSequenceHopping-r17 | ENUMERATED { neither, |

groupHopping, sequenceHopping },

| | |
|---|---|
| resourceType-r17 | CHOICE { |
| aperiodic-r17 | SEQUENCE { |
| slotOffset-r17 | INTEGER (1..32) |

| | |
|---|---|
| OPTIONAL, | -- Need S |

```
      ...
    },
```

| | |
|---|---|
| semi-persistent-r17 | SEQUENCE { |
| periodicityAndOffset-sp-r17 | SRS- |

```
PeriodicityAndOffset-r17,
      ...
    },
```

| | |
|---|---|
| periodic-r17 | SEQUENCE { |
| periodicityAndOffset-p-r17 | SRS- |

```
PeriodicityAndOffset-r17,
      ...
    }
  },
```

| | |
|---|---|
| sequenceId-r17 | INTEGER (0..65535), |
| spatialRelationInfoTimeSync-r17 | SRS- |
| SpatialRelationInfoTimeSync-r17 | OPTIONAL, -- Need R |

...
}

### Section 2-2: Semi-Persistent SRS Based Procedure:

Alternatively, the SRS can be semi-persistent SRS (SP-SRS). The SP-SRS transmission periodicity is a function of the PD (propagation delay) estimation refresh periodicity. The PD refresh periodicity can be a function of the periodicity of the accurate reference time refresh from the gNB to the UE and/or the periodicity of the gPTP message refresh from the TSN master clock to the TSN slave clock. Additionally/alternatively, the PD estimation refresh periodicity can be configured independent of the upper layer reference time refresh.

The SP-SRS transmission has an offset relative to the PD refresh periodicity.

For example, the SP-SRS periodicity is set to be the same as PD refresh periodicity, and the offset is applied such as the SP-SRS is sent ahead of time so that PD estimation procedure can be finished before the estimated PD value is demanded by TSN application, for example, to time stamp the incoming/outgoing gPTP messages.

With SP-SRS, the SRS transmission is transmitted periodically once triggered.

Thus, in one embodiment, as shown in FIG. 12, the procedure is carried out as follows:
Step (a): The gNB sends the RRC configuration for the SP-SRS, including time and frequency domain parameters of the SP-SRS.
Step (b): The gNB sends a downlink signal to trigger the SP-SRS transmission on the uplink.
Step (c): The triggered SP-SRS is sent from UE to gNB with the configured periodicity, offset.
Step (d): For each time instance the PD estimation is needed,
   the gNB performs uplink timing detection based on the transmitted SP-SRS and derives the timing information; and
   the gNB sends the timing information to the UE with either a timing advance adjustment MAC CE (e.g., time sensitive communication (TSC) MAC CE) or RRC message containing the accurate reference time with propagation delay pre-compensated.

In a variant of the embodiment described with reference to FIG. 12, additionally, the periodic SRS transmission is valid only for a configurable period. The period can be configured as absolute time values such as 5 ms, 10 ms or as the number of SRS periodic such as 10 SRS periods, 20 SRS periods, and etc. In a follow up network implementation example, the validity period is set so that it at least extends till the time where the accurate reference time (with PD compensated) would be needed at the UE for TSN application. In another network implementation example, the duration of the validity period is a function of UL channel condition, time sync requirements and etc. For example, the valid period should be long for a worse UL channel condition or a stringent sync requirement, since it is expected that with more SRS transmissions, the estimation would become better.

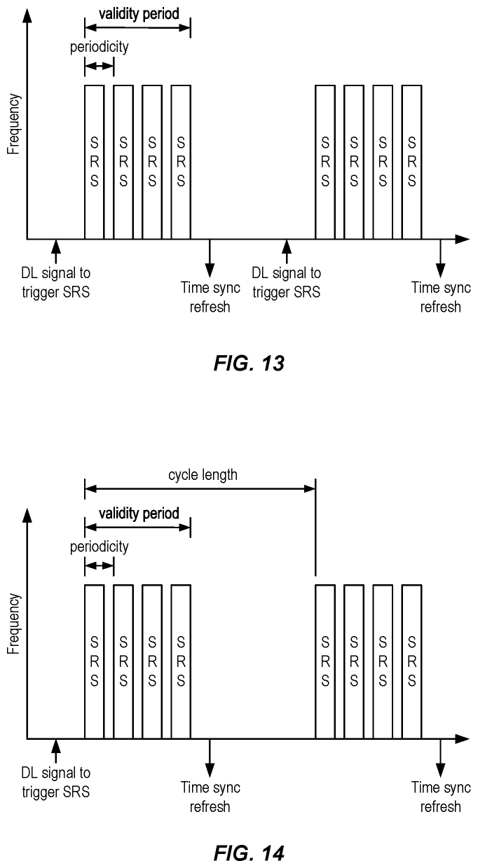

Thus, as shown in FIG. 13, the procedure is carried out as follows:
Step (a): The gNB sends the RRC configuration for the SP-SRS, including time and frequency domain parameters of the SP-SRS, and additionally the validity period.
Step (b): The gNB sends a downlink signal to trigger the SP-SRS transmission on the uplink.
Step (c): The triggered SP-SRS is sent from UE to gNB with the configured periodicity, offset and validity period;
Step (d): For each time instance the PD estimation is needed,
   The gNB performs uplink timing detection based on the transmitted SP-SRS and derives the timing information; and
   The gNB sends the timing information to the UE with either a timing advance adjustment MAC CE (e.g., time sensitive communication (TSC) MAC CE) or RRC message containing the accurate reference time with propagation delay pre-compensated.

In another variant of the embodiment described with reference to FIG. 12, the SRS transmission opportunity is spaced out in time by the cycle length (e.g., 50 ms, 100 ms), as shown in FIG. 14. At each SRS transmission opportunity, the SRS is transmitted repeatedly within a validity period (or a number of repetitions). When gNB sends a DL signal to trigger the SRS, then the SRS transmission opportunities occur periodically, until another DL signal is sent by gNB to terminate the SRS transmission. At the end of an SRS transmission opportunity, the time synchronization between gNB and UE can be estimated and updated (i.e., time sync refresh) using all SRS repetitions within one SRS transmission opportunity.

It is noted that for the embodiments as described above, other types of parameters can be used to achieve similar or same effect. For example, the validity period can be equivalently provided by the number of SRS instances to transmit in one transmission opportunity, e.g., 4 SRS instances for each transmission opportunity in the example of FIG. 13.

### Section 2-3: Periodic SRS Based Procedure:

Alternatively, the SRS can be periodic SRS (P-SRS). The P-SRS transmission periodicity is a function of the PD (propagation delay) estimation refresh periodicity. The PD refresh periodicity can be set in a similar fashion as the one for the semi-persistent SRS. The P-SRS transmission has an offset relative to the PD refresh periodicity. For example, the P-SRS periodicity is set to be the same as PD refresh periodicity, and the offset is applied such as the P-SRS is sent ahead of time so that PD estimation procedure can be finished before the estimated PD value is demanded by TSN application.

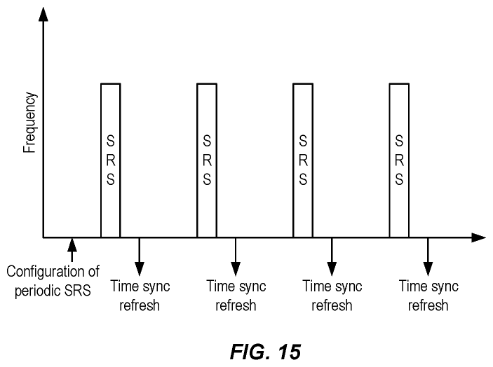

With P-SRS, the SRS transmission is transmitted periodically after RRC configuration of the periodically SRS is provided to the UE. Thus, as shown in FIG. 15, the procedure is carried out as follows:
Step (a): The gNB sends the RRC configuration for periodic SRS transmission.
Step (b): After receiving the RRC configuration, the UE starts to transmit the P-SRS according to the configuration provided by gNB, including the periodicity and offset.
Step (c): For each time instance the PD estimation is needed,
   The gNB performs uplink timing detection based on the transmitted P-SRS and derives the timing information; and
   The gNB sends the timing information to the UE with either a timing advance adjustment MAC CE (e.g., time sensitive communication (TSC) MAC CE) or RRC message containing the accurate reference time with propagation delay pre-compensated.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the scope of the disclosure as those skilled in the art readily understand. Such modifications and variations are considered to be within the scope of the disclosure and the appended claims. The protection scope of the disclosure is defined by the accompanying claims.

Some example embodiments of the present disclosure are as follows:

Embodiment 1: A method for time synchronization between an access node and a wireless communication device in a wireless communication network, comprising the following steps carried out at the access node:
a) receiving a Physical Random Access Channel (PRACH) preamble for enhancing timing detection from the wireless communication device, wherein transmission of the preamble for enhancing timing detection occupies more or separate physical resources as compared to one without a purpose of enhancing timing detection;
b) deriving timing-related information based on the preamble for enhancing timing detection; and
c) sending the timing-related information or clock time for the wireless communication device determined based on the timing-related information to the wireless communication device.

Embodiment 2: The method according to claim 1, wherein the access node is eNB or gNB, and the wireless communication device is selected from a group consisting of User Equipment (UE), Tablet, mobile terminals, smart phone, laptop embedded equipped, laptop mounted equipment, and Internet of Things (IOT) device.

Embodiment 3: The method according to claim 2, wherein the timing-related information is at least one of absolute timing advance (TA), TA adjustment, and propagation delay (PD).

Embodiment 4: The method according to claim 3, wherein the timing-related information is included in a TA command signaled with a granularity smaller or finer than a granularity for normal transmission timing adjustment for Physical Uplink Control Channel (PUCCH)/Physical Uplink Shared Channel (PUSCH)/Sounding Reference Signal (SRS).

Embodiment 5: The method according to claim 3, wherein the physical resources for the transmission of the preamble for enhancing timing detection are shared by all wireless devices in a cell associated with the access node.

Embodiment 6: The method according to claim 5, wherein Radio Access Channel (RACH) configuration is cell-specific and common to all wireless communication devices in the cell associated with the access node.

Embodiment 7: The method according to claim 3, the preamble for enhancing timing detection is different from one for a use case of non-Time Sensitive Network (TSN), and a portion of PRACH resources in a cell associated with the access node are reserved for the transmission of the preamble for enhancing timing detection.

Embodiment 8: The method according to claim 3, the wireless communication device is in a RRC CONNECTED State and prior to step a), comprising: triggering a Radio Access Channel procedure by PDCCH including Downlink Control Information (DCI) format specifying which PRACH occasion(s) are configured for the enhancing timing detection so that the wireless communication device transmits the preamble for enhancing timing detection by dedicated PRACH resources.

Embodiment 9: The method according to claim 8, wherein the dedicated PRACH resources are shared by all wireless communication device or allowable to be used by a group of wireless devices in a cell associated with the access node.

Embodiment 10: The method according to claim 8 or 9, wherein a PRACH mask signaled by the DCI is used for filtering the dedicated PRACH resources or determining a common PRACH resources for enhancing timing detection.

Embodiment 11: The method according to anyone of claims 1-10, wherein PRACH configuration for clock synchronization has a configurable time domain modification.

Embodiment 12: The method according to anyone of claims 1-11, wherein a higher power ramping step and/or a smaller back-off time are used for enhancing timing detection.

Embodiment 13: A method for time synchronization between an access node and a wireless communication device in a wireless communication network, comprising the following steps carried out at the access node:
a) receiving an Uplink (UL) Reference Signal (RS) from the wireless communication device;
b) deriving timing-related information based on the UL RS; and
c) sending the timing-related information or clock time for the wireless communication device determined based on the timing-related information to the wireless communication device.

Embodiment 14: The method according to claim 13, wherein the access node is eNB or gNB, and the wireless communication device is selected from a group consisting of User Equipment (UE), Tablet, mobile terminals, smart phone, laptop embedded equipped, laptop mounted equipment, and Internet of Things (IOT) device.

Embodiment 15: The method according to claim 14, wherein the UL RS is one selected from a group consisting of wideband or enhanced Sounding Reference Signal (SRS), Demodulation Reference Signal (DMRS) and Phase Tracking Reference Signal (PTRS).

Embodiment 16: The method according to claim 14 or 15, wherein the timing-related information is at least one of absolute timing advance, TA adjustment, and propagation delay.

Embodiment 17: The method according to claim 13, prior to step-a), comprising sending to the wireless communication device a downlink (DL) signal to trigger the UL RS transmission.

Embodiment 18: A method for time synchronization between an access node of a wireless communication network and a wireless communication device, comprising the following steps carried out at the access node:
a) sending to the wireless communication device configuration according to which the wireless communication device carries out multiple UL RS transmission; and
b) each time when receiving one UL RS from the wireless communication device or a predetermined number of UL RSs from the wireless communication device, deriving a respective timing-related information based on the received UL RS(s) and sending the respective timing-related information or clock time for the wireless communication device determined based on the respective timing-related information to the wireless communication device.

Embodiment 19: The method according to claim 18, wherein the access node is eNB or gNB, and the wireless communication device is selected from a group consisting of User Equipment (UE), Tablet, mobile terminals, smart phone, laptop embedded equipped, laptop mounted equipment, and Internet of Things (IOT) device.

Embodiment 20: The method according to claim 19, wherein the UL RS is one selected from a group consisting of wideband or enhanced Sounding Reference Signal (SRS), Demodulation Reference Signal (DMRS) and Phase Tracking Reference Signal (PTRS).

Embodiment 21: The method according to claim 19 or 20, wherein the timing-related information is at least one of absolute timing advance, TA adjustment, and propagation delay.

Embodiment 22: The method according to claim 18, wherein the configuration is RRC configuration specifying a periodicity of the multiple UL RS transmission and an offset for the periodicity of the multiple UL RS transmission in relation to Propagation Delay (PD) refresh periodicity.

Embodiment 23: The method according to claim 18, wherein the configuration is RRC configuration specifying a periodicity of the multiple UL RS transmission, a validity period for the multiple UL RS transmission and an offset for the periodicity of the multiple UL RS transmission in relation to Propagation Delay (PD) refresh periodicity.

Embodiment 24: The method according to claim 22 or 23, prior to step-b), comprising triggering the multiple UL RS transmission by sending a downlink (DL) signal to the wireless communication device.

Embodiment 25: An access node, comprising:
at least one processor; and
a memory containing program code executable by the at least one processor,
whereby execution of the program code by the at least one processor causes the access node to perform a method according to anyone of claims 1-24.

Embodiment 26: A computer program product being embodied in a computer readable storage medium and comprising program code to be executed by at least one processor of an access node, whereby execution of the program code causes the access node to perform a method according to anyone of claims 1-24.

Embodiment 27: A method for time synchronization between an access node and a wireless communication device in a wireless communication network, comprising the following steps carried out at the wireless communication device:
a) transmitting to the access node a Physical Random Access Channel (PRACH) preamble for enhancing timing detection, wherein transmission of the preamble for the enhancing timing detection occupies more or separate physical resources as compared to one without a purpose of enhancing timing detection; and
b) receiving from the access node timing-related information derived based on the preamble for enhancing timing detection or clock time for the wireless communication device determined based on the timing-related information.

Embodiment 28: The method according to claim 27, wherein the access node is eNB or gNB, and the wireless communication device is selected from a group consisting of User Equipment (UE), Tablet, mobile terminals, smart phone, laptop embedded equipped, laptop mounted equipment, and Internet of Things (IOT) device.

Embodiment 29: The method according to claim 28, wherein the timing-related information is at least one of absolute timing advance (TA), TA adjustment, and propagation delay (PD).

Embodiment 30: The method according to claim 28 or 29, wherein the timing-related information is included in a TA command signaled with a granularity smaller or finer than a granularity for normal transmission timing adjustment for Physical Uplink Control Channel (PUCCH)/Physical Uplink Shared Channel (PUSCH)/Sounding Reference Signal (SRS).

Embodiment 31: The method according to claim 28 or 29, wherein the physical resources for the transmission of the preamble for enhancing timing detection are shared by all wireless devices in a cell associated with the access node.

Embodiment 32: The method according to claim 28 or 29, the preamble for enhancing timing detection is different from one for a use case of non-Time Sensitive Network (TSN), and a portion of PRACH resources in a cell associated with the access node are reserved for the transmission of the preamble for enhancing timing detection.

Embodiment 33: The method according to claim 28 or 29, the wireless communication device is in a RRC CONNECTED State and prior to step-a), comprising: receiving a PDCCH order including Downlink Control Information (DCI) format specifying which PRACH occasion(s) are configured for the enhancing timing detection so that the wireless communication device transmits the preamble for enhancing timing detection by dedicated PRACH resources.

Embodiment 34: The method according to claim 33, wherein the dedicated PRACH resources are shared by all wireless communication device or allowable to be used by a group of wireless devices in a cell associated with the access node.

Embodiment 35: A method for time synchronization between an access node and a wireless communication device in a wireless communication network, comprising the following steps carried out at the wireless communication device:
a) transmitting an Uplink (UL) Reference Signal (RS) to the access node; and
b) receiving from the access node timing-related information derived based on the UL RS or clock time for the wireless communication device determined based on the timing-related information.

Embodiment 36: The method according to claim 35, wherein the access node is eNB or gNB, and the wireless communication device is selected from a group consisting of User Equipment (UE), Tablet, mobile terminals, smart phone, laptop embedded equipped, laptop mounted equipment, and Internet of Things (IOT) device.

Embodiment 37: The method according to claim 36, wherein the UL RS is one selected from a group consisting of wideband or enhanced Sounding Reference Signal (SRS), Demodulation Reference Signal (DMRS) and Phase Tracking Reference Signal (PTRS).

Embodiment 38: The method according to claim 36 or 37, wherein the timing-related information is at least one of absolute timing advance, TA adjustment, and propagation delay.

Embodiment 39: The method according to claim 36, prior to step-a), comprising receiving from the access node a downlink (DL) signal to trigger the UL RS transmission.

Embodiment 40: A method for time synchronization between an access node and a wireless communication device in a wireless communication network, comprising the following steps carried out at the wireless communication device:
a) receiving from the access node configuration according to which the wireless communication device carries out multiple UL RS transmission;
b) each time after transmitting one UL RS to the access node or a predetermined number of UL RSs to the access node, receiving from the access node a respective timing-related information derived based on the transmitted UL RS(s) or clock time for the wireless communication device determined based on the respective timing-related information.

Embodiment 41: The method according to claim 40, wherein the access node is eNB or gNB, and the wireless communication device is selected from a group consisting of User Equipment (UE), Tablet, mobile terminals, smart phone, laptop embedded equipped, laptop mounted equipment, and Internet of Things (IOT) device.

Embodiment 42: The method according to claim 41, wherein the UL RS is one selected from a group consisting of wideband or enhanced Sounding Reference Signal (SRS), Demodulation Reference Signal (DMRS) and Phase Tracking Reference Signal (PTRS).

Embodiment 43: The method according to claim 41 or 42, wherein the timing-related information is at least one of absolute timing advance, TA adjustment, and propagation delay.

Embodiment 44: The method according to claim 40, wherein the configuration is RRC configuration specifying a periodicity of the multiple UL RS transmission and an offset for the periodicity of the multiple UL RS transmission in relation to Propagation Delay (PD) refresh periodicity.

Embodiment 45: The method according to claim 40, wherein the configuration is RRC configuration specifying a periodicity of the multiple UL RS transmission, a validity period for the multiple UL RS transmission and an offset for the periodicity of the multiple UL RS transmission in relation to Propagation Delay (PD) refresh periodicity.

Embodiment 46: The method according to claim 44 or 45, prior to step-b), comprising receiving from the access node a downlink (DL) signal for triggering the multiple UL RS transmission.

Embodiment 47: A wireless communication device, comprising:
at least one processor; and
a memory containing program code executable by the at least one processor,
whereby execution of the program code by the at least one processor causes the wireless communication device to perform a method according to anyone of claims 27-46.

Embodiment 48: A computer program product being embodied in a computer readable storage medium and comprising program code to be executed by at least one processor of an access node, whereby execution of the program code causes the wireless communication device to perform a method according to anyone of claims 27-46.

Those skilled in the art will recognize improvements and modifications to the embodiments of the present disclosure. All such improvements and modifications are considered within the scope of the concepts disclosed herein.

1. A method performed by a wireless communication device, the method comprising:
transmitting, to an access node, a signal for enhanced uplink timing estimation, wherein the signal occupies more or separate physical resources as compared to a corresponding signal transmitted for a purpose other than enhanced uplink timing estimation; and
receiving, from the access node, a message comprising timing-related information or clock time, responsive to transmitting the signal for enhanced uplink timing estimation.

2. The method of claim 1 wherein the signal for enhanced uplink timing estimation is a physical random access channel, PRACH, preamble for enhanced uplink timing estimation, wherein the PRACH preamble for enhanced uplink timing estimation occupies more or separate physical resources as compared to a PRACH preamble for a purpose other than enhanced uplink timing estimation.

3. The method of claim 2 wherein the message comprising the time-related information or clock time is a random access response.

4. The method of claim 2 wherein the PRACH preamble has a bandwidth that is greater than 12 Physical Resource Blocks, PRBs, and the PRACH preamble for a purpose other than enhanced uplink timing estimation is 12 PRBs.

5. The method of claim 4 wherein each PRB has a bandwidth of 15·2^{μ}·12 kilohertz, wherein 15·2^{μ} kilohertz is a subcarrier spacing of a respective cell on which the PRACH preamble.

6. The method of claim 2 wherein the message comprises the timing-related information.

7. The method of claim 6 wherein the timing-related information comprises at least one of an absolute timing advance, a timing advance adjustment, and a propagation delay.

8. The method of claim 6 wherein the timing-related information comprises a timing advance command the timing advance command has a granularity of K/2μ, 15·2^{μ} kilohertz where μ is an integer greater than or equal to zero is a subcarrier spacing of a respective cell on which the PRACH preamble is transmitted, and K is less than 1,024.

9. The method of claim 8 wherein K is a power of 2 value.

10. The method of claim 8 wherein K is 512, 256, 128, 64, 32, or 16.

11. The method of claim 2 wherein the PRACH preamble is transmitted on a PRACH resource from a common set of PRACH resources for all wireless communication devices in a respective cell on which the PRACH preamble is transmitted.

12. The method of claim 2 wherein transmitting the PRACH preamble comprises transmitting the PRACH preamble in accordance with a RACH configuration that is cell-specific and common to all wireless communication devices in a respective cell on which the PRACH preamble is transmitted.

13. The method of claim 11 wherein the PRACH preamble is one of a first set of PRACH preambles dedicated for time synchronization, the first set of PRACH preambles being different than a second set of PRACH preambles defined for the cell for random access for a purpose other than enhanced uplink timing estimation.

14. The method of claim 13 wherein the wireless communication device transmits the PRACH preamble from the first set of PRACH preambles responsive to an indication from an upper layer that the random access procedure is for TSN time synchronization or an indication that a TSN protocol was started at the wireless communication device.

15. The method of claim 2 wherein transmitting the PRACH preamble is triggered by a downlink signal.

16. The method of claim 2 wherein transmitting the PRACH preamble while the wireless communication device is in a connected state.

17. The method of claim 16 wherein transmitting the PRACH preamble is triggered by a downlink control information, DCI, received from the access node while the wireless communication device is in the connected state.

18. The method of claim 17 wherein the DCI comprises a field that points to one or more PRACH occasions that are configured for enhanced uplink timing estimation.

19. The method of claim 16 wherein transmitting the PRACH preamble while the wireless communication device is in the connected state is in accordance with a configuration received via device-specific or group-specific signaling.

20. The method of claim 2 wherein the PRACH preamble is transmitted on a dedicated PRACH resource, and a PRACH mask index value defined for clock synchronization in a Time-Sensitive Network, TSN, is used for the dedicated PRACH resource.

21. The method of claim 2 wherein transmitting the PRACH preamble comprises transmitting the PRACH preamble in accordance with a PRACH configuration for enhanced uplink timing estimation, wherein the PRACH configuration for enhanced uplink timing estimation is the same as a PRACH configuration for a purpose other than enhanced uplink timing estimation but with a configurable time domain modification.

22. The method of claim 2 wherein transmitting the PRACH preamble comprises transmitting the PRACH preamble in accordance with:
a first power ramping step size that is greater than a second power ramping step size used for PRACH preamble transmission for a purpose other than enhanced uplink timing estimation;
a first back-off time that is smaller than a second back-off time used for PRACH preamble transmission for a purpose other than enhanced uplink timing estimation; or
both the first power ramping step size and the first back-off time.

23. The method of claim 1 wherein the signal for enhanced uplink timing estimation comprises one or more uplink reference signals for enhanced uplink timing estimation, wherein the one or more uplink reference signals for enhanced uplink timing estimation occupy more or separate physical resources as compared a corresponding one or more reference signals transmitted for a purpose other than enhanced uplink timing estimation.

24-38. (canceled)

39. A wireless communication device comprising:
a radio interface; and
one or more processors associated with the radio interface, the one or more processors configured to cause the wireless communication device to:
transmit, to an access node, a physical random access channel, PRACH, preamble for enhanced uplink timing estimation, wherein the PRACH preamble for enhanced uplink timing estimation occupies more or separate physical resources as compared to a PRACH preamble for a purpose other than enhanced uplink timing estimation; and
receive, from an access node, a random access response comprising timing-related information or clock time, responsive to transmitting the PRACH preamble.

40. (canceled)

41. A method performed by an access node, the method comprising:
receiving, from a wireless communication device, a signal for enhanced uplink timing estimation, wherein the signal for enhanced uplink timing estimation occupies more or separate physical resources as compared to a corresponding signal for a purpose other than enhanced uplink timing estimation;
deriving timing-related information based on the signal for enhanced uplink timing estimation; and
transmitting, to the wireless communication device, a message comprising timing-related information or clock time, responsive to transmitting the signal for enhanced uplink timing estimation.

42-76. (canceled)

77. An access node comprising one or more processors configured to cause the access node to:
receive, from a wireless communication device, a physical random access channel, PRACH, preamble for enhanced uplink timing estimation, wherein the PRACH preamble for enhanced uplink timing estimation occupies more or separate physical resources as compared to a PRACH preamble for a purpose other than enhanced uplink timing estimation;
derive timing-related information based on the PRACH preamble for enhanced uplink timing estimation; and
transmit, to the wireless communication device, a random access response comprising timing-related information or clock time, responsive to transmitting the PRACH preamble.

78. (canceled)
